(19) United States
(12) Patent Application Publication
(10) Pub. No.: US 2015/0370999 A1
(43) Pub. Date: Dec. 24, 2015

(54) METHOD AND SYSTEM FOR PROVIDING PRESCRIPTION-BASED BIOMETRIC MONITORING

(71) Applicant: VERIZON PATENT AND LICENSING INC., Arlington, VA (US)

(72) Inventor: Kenneth Scott CARPENTER, Rockwall, TX (US)

(21) Appl. No.: 14/311,939

(22) Filed: Jun. 23, 2014

(51) Int. Cl. G06F 19/00

(52) U.S. Cl. CPC G06F 19/3456; G06F 19/3431; G06F 19/322; G06F 19/3418

(57) ABSTRACT

An approach for triggering an alert notification associated with an electronic prescription. The approach includes receiving an electronic prescription associated with a patient. The electronic prescription specifies a biometric parameter and a prescribed range for the biometric parameter. The approach also includes receiving a biometric value for the biometric parameter collected by a monitoring device based on the electronic prescription. The monitoring device is associated with the patient. The approach also includes triggering an alert notification based on a comparison of the biometric value against the prescribed range.

### BACKGROUND OF THE INVENTION

Service providers and device manufacturers (e.g., wireless, cellular, etc.) are continually challenged to deliver value and convenience to consumers by, for example, providing compelling network services. One area of interest has been the development of health monitoring devices (or devices for monitoring biometric parameters in general, e.g., wearable health sensors, integrated health monitors on mobile devices and smartphones, etc.), as well as the integration of these monitoring devices with an increasingly electronic medical record system. In particular, challenges include enabling end users more control of do-it-yourself options for health monitoring while ensuring that such monitoring comply with professional standards of care and applicable regulations.

Based on the foregoing, there is need for integration of medical professional oversight of individualized health monitoring that allows for the convenience of self-monitoring by an end user or patient.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of an architecture for receiving an electronic prescription and triggering an alert notification, according to an embodiment;

FIG. 2 is a diagram of the components of an electronic medical records platform for use with a service provider network, according to an embodiment;

FIG. 3A-3C are flowcharts of processes for receiving an electronic prescription and triggering an alert notification, according various embodiments;

FIG. 4A-4C are graphical representations of electronic prescriptions entered via prescribing user interface, according to various embodiments; and

FIG. 5 is a diagram of a computer system that can be used to implement various exemplary embodiments; and

FIG. 6 is a diagram of a chip set that can be used to implement an embodiment of the invention.

### DETAILED DESCRIPTION OF THE PREFERRED EMBODIMENTS

An apparatus, method, and system for receiving an electronic prescription, receiving a biometric value, triggering an alert notification, and combinations thereof, are described. The embodiments of the invention provide a system whereby personalized monitoring is linked with specific instructions from qualified health professionals (e.g., through electronic prescriptions). In this way, users are able to obtain personalized, but yet still automated monitoring. In the following description, for the purposes of explanation, numerous specific details are set forth in order to provide a thorough understanding of the present invention. As is well known, the present invention may be practiced without these specific details or with an equivalent arrangement. In other instances, well-known structures and devices are shown in block diagram form in order to avoid unnecessarily obscuring the present invention.

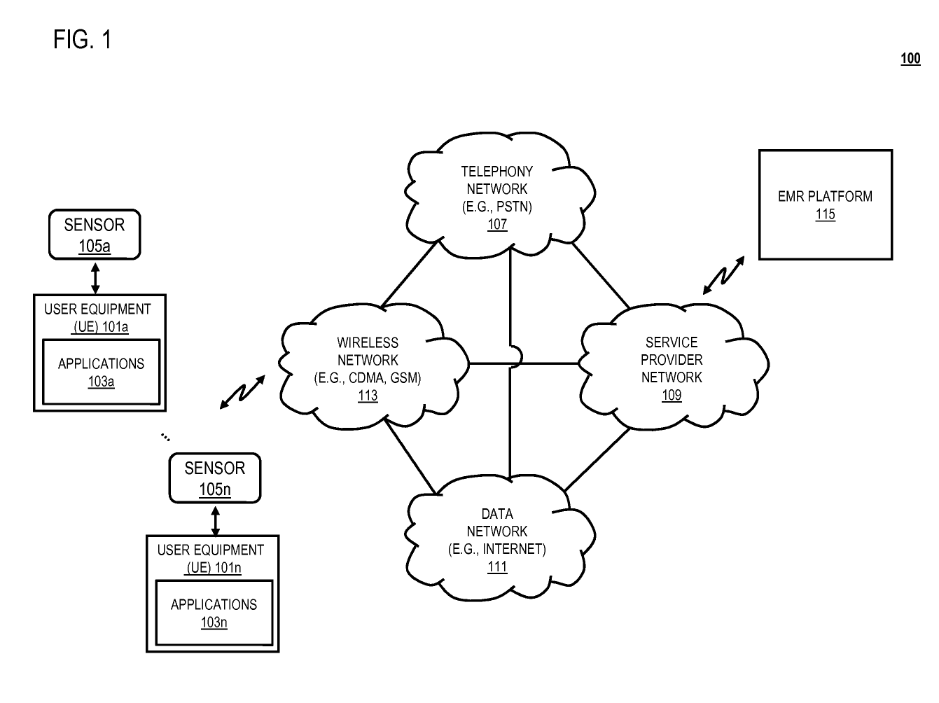

FIG. 1 is a diagram of a system for enabling the transmission of files independent of a file transfer application or the throughput capabilities of the sending or receiving devices, according to one embodiment. Modern healthcare provisioning often includes collecting patient-specific biometric information obtained by a variety of systems and methods. Traditionally, biometric information has been gathered from patients utilizing processes that require a patient to visit a healthcare provider or a healthcare facility, such as a hospital. Monitoring devices are available for collecting biometric information outside the traditional locations. However, the collecting of biometric information often requires a user to initiate transmission of biometric data, often transmitted on a sporadic basis.

The biometric information collected from various locations is commonly ambient or normal. Much of the biometric information collected often has little or no relevance in determining whether a health intervention may be needed for a patient. Commonly, the biometric information collected must be reviewed, on a constant or ongoing basis or through an extensive review of collected data in a patient history record. These practices are often wasteful as much of the data collected often merely indicates that no intervention should be implemented or considered. This wastes a significant amount of time for healthcare provider having responsibility for reviewing the data and causes an inefficient utilization of resources associated with an EMR platform that collects and stores the biometric information. Furthermore, health regulations (e.g., FDA regulations) have prevented manufacturers from personalizing health monitoring information on monitoring devices for individuals because of concerns about encroaching on clinician responsibilities. As a result, device manufacturers have had to forego including personalized features in monitoring devices.

To address these problems, a system 100 of FIG. 1 enables users (e.g., both medical professionals and patients) to use a rules engine to monitor user biometric or health parameters (e.g., heart rate, blood pressure, oxygen level, respiration, etc.) against prescribed ranges or boundaries specified in, for instance, electronic prescriptions (also referred to as “e-prescriptions” created by medical professional). By way of example, the system 100 include functions related to: (1) prescribing a biometric parameter and associated monitoring ranges for a patient; (2) registering/de-registering the patent with an electronic medical records system; (3) utilizing a rules engine to determine if monitored biometric values are in-bounds or out-of-bounds; (4) triggering alert messages to clinicians and others based on the monitoring; and/or (5) displaying and/or storing biometric values within the patient's electronic medical records. In this way, the system 100 enables patients to advantageously personalize monitoring ranges (e.g., the prescribed ranges) while remaining under the oversight of a medical professional via the electronic prescription.

In one embodiment, when a medical professional accesses a prescription user interface of the system 100 to prescribe monitoring for a patient, the medical professional will also specify the prescribed range specifically for the patient. In one embodiment, the fields for prescribing the ranges will be made available within the prescription user interface. When the medical professional or clinician creates the prescription, the prescription can be authenticated using, for instance, an electronic signature (also referred to as an “e-signature”). In one embodiment, the prescribed biometric parameter and its corresponding prescribed range may then be sent to a rules engine for monitoring and analysis of biometric values collected from a monitoring device. In some embodiments, the system 100 can also interface with an electronic medical records system to register the patient, the electronic prescription, and/or the electronic monitoring data. In yet another embodiment, the system 100 may automatically initiate an order for delivery of any prescribed monitoring devices to the patient.

As shown in FIG. 1, the system 100 comprises user equipment (UE) 101a-101n (collectively referred to as UE 101) for collecting and transmitting biometric information from a patient that may include or be associated with applications 103a-103n (collectively referred to as applications 103) for processing the biometric information and sensors 105a-105n (collectively referred to as sensors 105) for collecting/receiving biometric information taken based on a patient's body or biological functions. In one embodiment, the UE 101 has connectivity to an electronic medical records (EMR) platform 115 via networks 107-113. In one embodiment, the EMR platform 115 performs one or more functions associated with receiving electronic prescription(s), receiving biometric information, triggering alert notification(s), and combinations thereof.

By way of example, the UE 101 may be a receiver and/or transmitter for physiological signals and may be used as a standalone telemedicine device or utilized in conjunction with other patient monitoring devices, such as a glucometer, weight scale, pulse oximeter, and blood pressure monitor. The UE 101 may be any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user such as “wearable” circuitry, etc.

By way of example, the applications 103 may be a remote monitoring software solution intended to collect and store biometric data from physiological measurement devices, such as those intended for use in the home. The applications 103 may be any type of application that is executable at the UE 101, such as media player applications, social networking applications, calendar applications, content provisioning services, location-based service applications, navigation applications and the like. In one embodiment, one of the applications 103 at the UE 101 may act as a client for the EMR platform 115 and may perform one or more functions associated with the functions of the EMR platform 115, such as by interacting with the EMR platform 115 over the networks 107-113, or by incorporating applications which may be utilized independently at the EMR platform 115.

By way of example, the sensors 105 may be sensors for determining physiological signals, such as sensors utilized in conjunction with other patient monitoring devices, such as a glucometer, weight scale, pulse oximeter, and blood pressure monitor. By way of example, the sensors 105 may be any type of sensor. In certain embodiments, the sensors 105 may include, for example, a global positioning sensor for gathering location data (e.g., GPS), a network detection sensor for detecting wireless signals or receivers for different short-range communications (e.g., Bluetooth, WiFi, Li-Fi, near field communication, etc.), temporal information, a camera/imaging sensor for gathering image data, an audio recorder for gathering audio data, and the like. In one scenario, the sensors 105 may include, light sensors, oriental sensors augmented with height sensor and acceleration sensor, tilt sensors, moisture sensors, pressure sensors, audio sensors (e.g., microphone), gaze tracking sensors etc.

For illustrative purposes, the networks 107-113 may be any suitable wireline and/or wireless network, and be managed by one or more service providers. For example, telephony network 107 may include a circuit-switched network, such as the public switched telephone network (PSTN), an integrated services digital network (ISDN), a private branch exchange (PBX), or other like network. Wireless network 113 may employ various technologies including, for example, code division multiple access (CDMA), enhanced data rates for global evolution (EDGE), general packet radio service (GPRS), mobile ad hoc network (MANET), global system for mobile communications (GSM), Internet protocol multimedia subsystem (IMS), universal mobile telecommunications system (UMTS), etc., as well as any other suitable wireless medium, e.g., microwave access (WiMAX), wireless fidelity (WiFi), satellite, and the like. Meanwhile, data network 111 may be any local area network (LAN), metropolitan area network (MAN), wide area network (WAN), the Internet, or any other suitable packet-switched network, such as a commercially owned, proprietary packet-switched network, such as a proprietary cable or fiber-optic network.

Although depicted as separate entities, networks 107-113 may be completely or partially contained within one another, or may embody one or more of the aforementioned infrastructures. For instance, the service provider network 109 may embody circuit-switched and/or packet-switched networks that include facilities to provide for transport of circuit-switched and/or packet-based communications. It is further contemplated that networks 107-113 may include components and facilities to provide for signaling and/or bearer communications between the various components or facilities of system 100. In this manner, networks 107-113 may embody or include portions of a signaling system 7 (SS7) network, or other suitable infrastructure to support control and signaling functions.

In one embodiment, the EMR platform 115 may be a platform with multiple interconnected components for processing medical records. The EMR platform 115 may include multiple servers, intelligent networking devices, computing devices, components and corresponding software for configuring one or more user interface elements for facilitating an installation of a device, a service, or a combination thereof. In addition, it is noted that the EMR platform 115 may be a separate entity of the system 100, or be included within the UE 101 (e.g., as part of the applications 103).

In one embodiment, the EMR platform 115 may receive an electronic prescription (i.e., an “e-prescription”) associated with a patient. The electronic prescription may specify one or more biometric parameter(s) (e.g., body temperature, heart rate, blood glucose level, etc.), one or more prescribed ranges for the biometric parameter(s) (e.g., temperature range, heart rate range, blood glucose level range, etc.), or a combination thereof. In one scenario, the EMR platform 115 may present a prescribing user interface for inputting an electronic prescription at the EMR platform 115. As an alternative, a user of system 100, such as a medical doctor or other healthcare provider, may transmit an electronic prescription record that is received at the EMR platform 115.

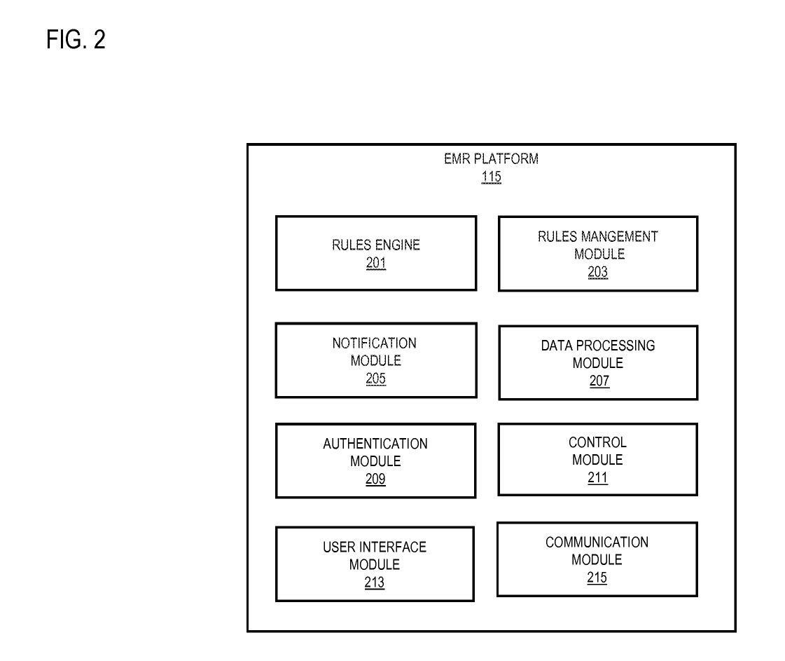

FIG. 2 is a diagram of the components of the EMR platform 115, according to one embodiment. By way of example, the EMR platform 115 includes one or more components for receiving electronic prescriptions; receiving biometric information, such as biometric values for biometric parameters collected by monitoring devices, such as UE 101, triggering alert notifications, such as those based on comparing biometric values against prescribed ranges; configuring rules engine(s) with monitoring rules; initiating registration of patient(s), delivery order(s) for monitoring devices, such as UE 101, creation of a medical record(s) associated with patient(s), updating of medical record(s), and combinations thereof based on electronic prescription(s); storing biometric value(s), contextual information (e.g., date, time, location, patient identifier, etc.) associated with the biometric value(s), alert notification(s), and combinations thereof stored in medical record(s) associated with patient(s); transmitting alert notification(s) to medical professional(s) which may be associated with electronic prescription(s), a patient, and combinations thereof; and performing authentication(s) of electronic prescription(s), medical professional(s) associated with electronic prescription(s), and combinations thereof.

It is contemplated that the functions of the components of the EMR platform 115 may be combined in one or more components or performed by other components of equivalent functionality. In this embodiment, the EMR platform 115 includes a rules engine 201, a rules management module 203, a notification module 205, a data processing module 207, an authentication module 209, a control module 211, a user interface module 213 and a communication module 215.

In one embodiment, the rules engine 201 processes information relating to establishing a monitoring rule associated with a patient and/or a medical prescription. A monitoring rule processed by the rules engine 201 may be, for example, a notification rule, a data recording rule, a data discarding rule, or a combination thereof. The monitoring rule may be based on a prescribed range of biometric parameters.

In one embodiment, the rules management module 203 allows a manager to create, define, modify, and delete rules and workflows that determine when an event in the EMR platform 115 triggers a status summary update and/or communication with a user, such as a health care provider or a patient. A user or the manager may identify exactly what has to happen to trigger a new event (e.g., events can be triggered by certain workgroups, types of users, or a person), and/or there can be exceptions built into the system, for example, conditional logic may be applied to the new trigger.

In one embodiment, the notification module 205 determines when and under what circumstances an alert notification may be associated with a biometric value and be reported to a medical care provider and/or a patient. The notification module 205 may also initiate a delivery order for a monitoring device and initiate a notification to a patient associated with the monitoring device so they can expect the delivery.

In one embodiment, the data processing module 207 processes and stores data including biometric information such as electronic prescriptions, biometric parameters and biometric values and notifications utilized by the EMR platform 115.

In one embodiment, the authentication module 209 authenticates electronic prescriptions and healthcare providers associated with the electronic prescriptions. The authentication module 209 may periodically communicate with trust sources regarding relevant tracking of the electronic prescriptions and prescribing healthcare providers. The authentication module 209 may also update its licensing records regarding the prescribing healthcare providers and any medications, therapies and biometric parameters associated with the electronic prescriptions.

In another embodiment, the authentication module 209 authenticates UE 101s for interaction with the EMR platform 115. In one embodiment, the authentication module 209 causes a verification of user information to configure at least one device to a secured network. In another embodiment, the authentication module 209 may detect an error during a user verification process based, at least in part, on predefined values, wherein predefined values include, at least in part, a preset username and password combination, a pin code, one or more identifiers, other authentication mechanisms, or a combination thereof. The authentication process performed by the module 209 may also include receiving and validating a login name and/or user identification value as provided or established for a particular user during a subscription or registration process with the service provider. The login name and/or user identification values may be received as input provided by the user from the UE 101 or other device via a graphical user interface to the EMR platform 115 (e.g., as enabled by the user interface module 213). Alternatively, the login process may be performed through automated association of profile data for the user and/or UE 101 with an IP address, a carrier detection signal of a user device, mobile directory number (MDN), subscriber identity module (SIM) (e.g., of a SIM card), radio frequency identifier (RFID) tag or other identifiers.

In one embodiment, the control module 211 is used to monitor events that occur in the EMR platform 115 for analysis using the rules engine 201 and/or the notification module 205. For example, the events include sensor streams from monitoring devices that deliver biometric values collected according to the electronic prescription. Other events include events indicating whether the monitored biometric values meet prescribed ranges and/or whether the values meet criteria for creating electronic medical records, updating the records, transmitting alerts, and/or activating any other function of the EMR platform 115.

In one embodiment, the user interface module 213 causes a presentation of one or more prescribing user interface(s) to assist at least one user in entering an electronic prescription, such as on a display associated with the EMR platform 115 and/or the UE 101. The user interface module 213 may employ various application programming interfaces (APIs) or other function calls corresponding to the applications 103 of UE 101, thus enabling the display of graphics primitives such as menus, data entry fields, etc., for generating the user interface elements. By way of example, the user interface module 213 generates the interface in response to APIs or other function calls corresponding to the browser application or web portal application of the UE 101, thus enabling the display of graphics primitives.

In one embodiment, the communication module 215 executes various protocols and data sharing techniques for connecting at least one device, such as a UE 101, to a secured network, thereby facilitating a presentation of user interface elements to assist at least one user in configuring at least one device to a secured network. The communication module 215 may be used to communicate biometric parameters, biometric values, alert notifications, commands, requests, data, etc. By way of example, the communication module 215 may be used to transmit a request from a UE 101 to the EMR platform 115 for receiving a biometric parameter and a prescribed range for the biometric parameter.

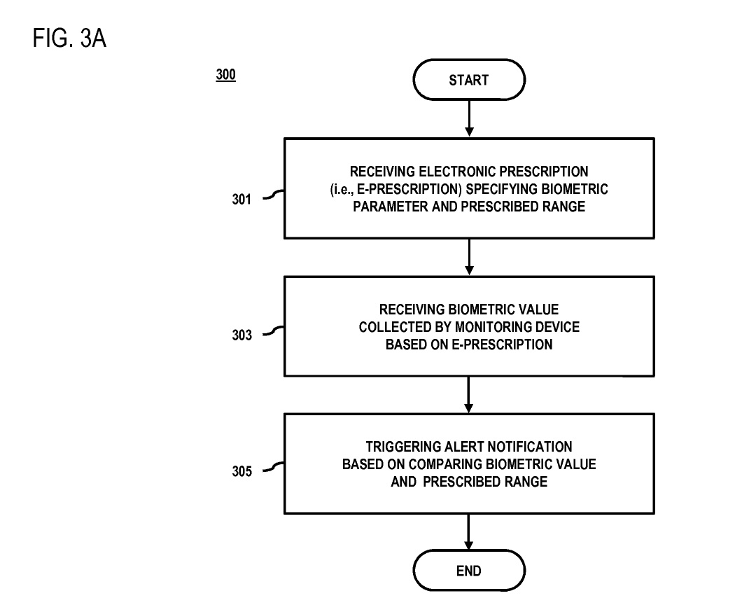

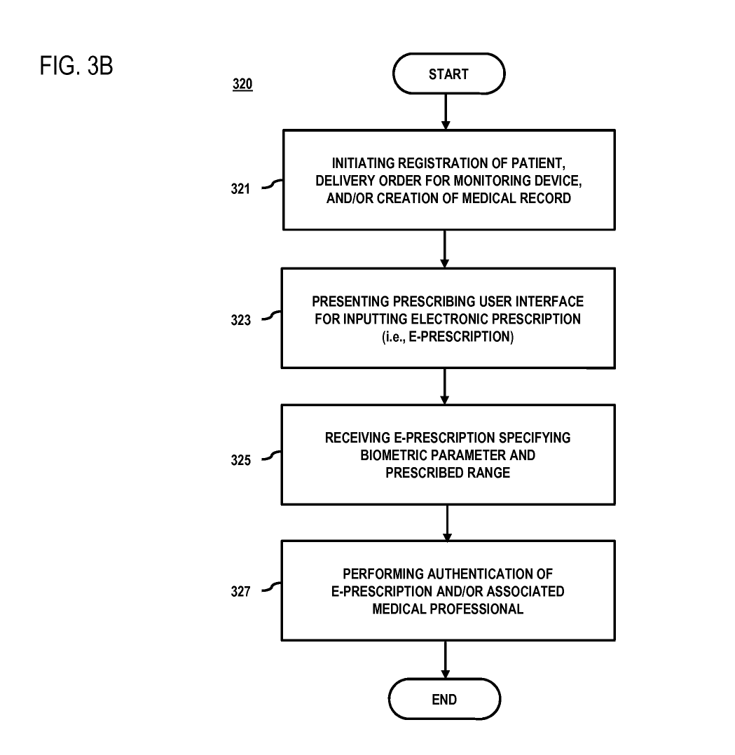

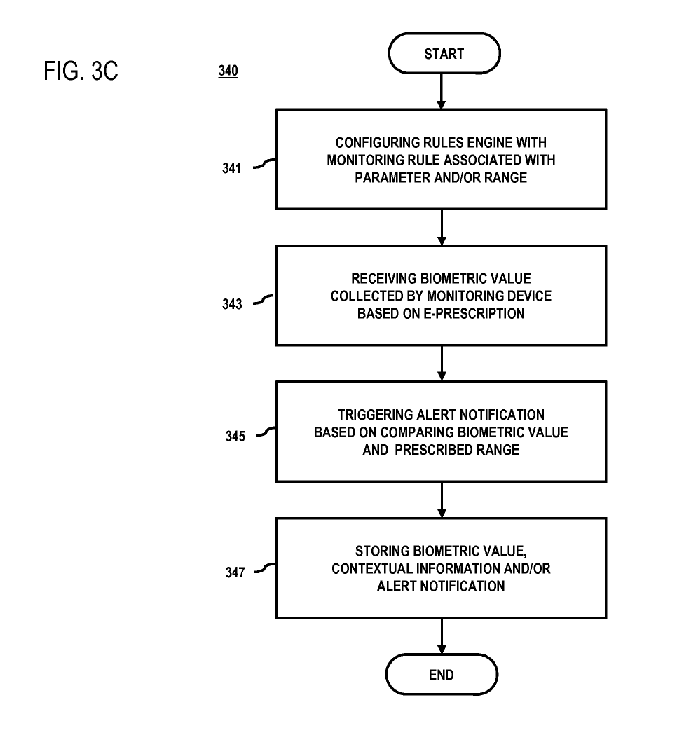

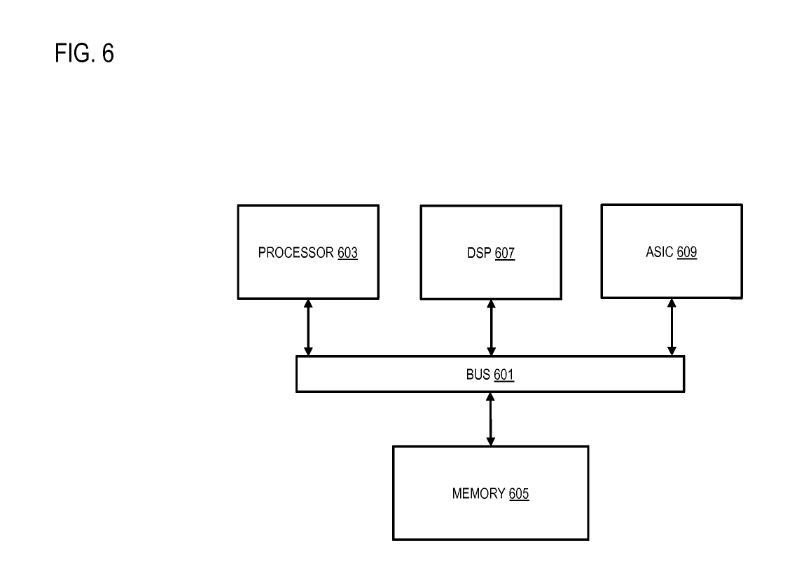

FIG. 3A is a flowchart of a process 300 for receiving an electronic prescription, receiving a biometric value and triggering an alert notification, according to one embodiment. In one embodiment, the EMR platform 115 performs process 300 and is implemented in, for instance, a chip set including a processor and a memory as shown in FIG. 6. In addition or alternatively, all or a portion of the process 300 may be performed by the UE 101 via the applications 103.

In step 301, the EMR platform 115 receives an electronic prescription specifying at least one biometric parameter (e.g., body temperature, body weight, heart rate, etc.) and at least one prescribed range (e.g., temperature range, weight range, range of heart rates, etc.). The received electronic prescription(s) and biometric parameter(s) are received at the EMR platform 115 by the communication module 215 and processed by the data processing module 207. In one scenario, the received electronic prescription(s) are authenticated by the authentication module 209.

In step 303, the EMR platform 115 receives at least one biometric value (e.g., a recorded or measured value of body temperature, body weight, heart rate, etc.). The received biometric value has been previously collected by a monitoring device, such as UE 101. The biometric value is associated with a biometric parameter in the electronic prescription, but the biometric value may be received at the EMR platform 115 before, after or concurrently with the electronic prescription received in step 301. The received biometric value(s) are received at the EMR platform 115 by the communication module 215 and processed by the data processing module 207.

In step 305, the rules engine 201 compares the received biometric value(s) with the prescribed range for the associated biometric parameter in the electronic prescription. In the event that any of the received biometric value(s) are outside the prescribed range of the associated biometric parameter(s), this triggers the notification module 205 to generate an alert notification that is processed and transmitted via the communication module 215.

FIG. 3B is a flowchart of a process 320 for initiating a patient registration, presenting a prescribing user interface, receiving an electronic prescription, and performing an authentication, according to one embodiment. In one embodiment, the EMR platform 115 performs process 320 and is implemented in, for instance, a chip set including a processor and a memory as shown in FIG. 6. In addition or alternatively, all or a portion of the process 300 may be performed by the UE 101 via the applications 103.

In step 321, the EMR platform 115 initiates, via the user interface module 213, a registration of a patient, a delivery order for a monitoring device and a creation of a medical record for the patient. For example, registration of the patient includes extracting patient data (e.g., name, address, etc.) from the electronic prescription and creating a medical record for the patient in the EMR platform 115. In one embodiment, the registration can be temporary for the prescribed duration of the electronic prescription. In another embodiment, the registration can be part of a permanent medical history of the patient. In other embodiments, such registration can be performed used anonymized identification data for the patient. In yet another embodiment, the platform may also initiate deregistration of the patient from the EMR platform 115 (e.g., at the end of a prescribed duration, based on monitoring rules, on patient request, etc.). Once initiated, at the user interface module 213, the data processing module 207 stores the patient registration and the medical record. In a scenario where a monitoring device is prescribed for the patient and the patient does not already have the device, the communication module 215 transmits the delivery order to a vendor and/or the patient for automatic delivery fulfillment. In another scenario, the medical record is updated via the communication module 215, for instance, when a patient medical record already exists, and new data meet monitoring rule criteria for storage of the collected biometric values.

In step 323, the user interface module 213 presents a prescribing user interface for inputting an electronic prescription. The prescribing user interface includes a first section for indicating patient information, a second section for selecting the monitoring device, a third section for selecting the biometric parameter and the prescribed range, or a combination thereof. It is noted that the sections are described by way of illustration and not limitation. It is contemplated that other sections may be included in the user interface to facilitate an input of electronic prescription. For example, an authentication section may be include to enable a prescribing medical professional to electronically sign and verify the validity of a prescription. It is contemplated that any authentication means may be employed by the EMR platform 115 to ensure the validity of an electronic prescription and/or the data contained therein.

In step 325, the EMR platform 115 receives, through user interface module 213, an electronic prescription specifying at least one biometric parameter and at least one prescribed range. In another scenario, EMR platform 115 receives an electronic prescription via the communication module 215.

In step 327, the EMR platform 115 performs an authentication of the received electronic prescription via the authentication module 209. For example, authentication may include verifying an electronic signature or other authentication credential associated with the electronic prescription.

FIG. 3C is a flowchart of a process 340 for configuring a rules engine, receiving a biometric value, triggering an alert notification and storing a biometric value, according to one embodiment. In one embodiment, the EMR platform 115 performs process 340 and is implemented in, for instance, a chip set including a processor and a memory as shown in FIG. 6. In addition or alternatively, all or a portion of the process 340 may be performed by the UE 101 via the applications 103.

In step 341, the rules management module 203 configures the rules engine 201 with a monitoring rule associated with a biometric parameter and a prescribed range associated with a received electronic prescription. The monitoring rule is associated with the biometric parameter, the prescribed range, a monitoring device, or a combination thereof based on the electronic prescription. In one embodiment, the monitoring rule may be specified in the electronic prescription. In other embodiments, the EMR platform 115 may apply a default monitoring rule and/or may select the appropriate monitoring rule depending on the type of monitoring, biometric parameter, prescribed range, etc. specified in the electronic prescription.

In step 345, the EMR platform 115 performs a comparison, utilizing the rules engine 201, of the received biometric value and the prescribed range and triggers an alert notification, via the notification module 205, based on the comparison. For example, in one embodiment, the monitoring rules may specify actions (e.g., registering, updating, storing, alerting, etc.) based on whether collected biometric rules meet or do not meet the prescribed range. In other embodiments, the rules may provide for additional logic or complexity such as, specifying different levels of alerts depending on the degree to which a value is out of bounds. In addition, the rules may specify different parties to notify based on the comparison. In other embodiments, the monitoring rules can be based on expert or artificial intelligence systems that can adaptively analyze the incoming biometric values and apply any programmed actions or series of actions.

In step 347, the EMR platform 115 stores the biometric value, contextual information associated with the biometric value and the alert notification, utilizing the data processing module 207. For example, storage of the biometric values include storing the data in the patient's electronic medical record, a cache, a temporary medical record, or any other storage means available to the EMR platform 115. As previously described, in one embodiment, the EMR platform 115 may determine whether and how to store the biometric value based the appropriate monitoring rule and/or based on the electronic prescription. For example, the electronic prescription may specify a storage location (e.g., the prescribing medical professional's storage platform, a cloud-based medical storage platform, local storage, etc.). In one embodiment, the storage location, terms, duration, etc. may be specified by the patient and/or the medical professional subject to any privacy and/or security regulations, agreements, etc.

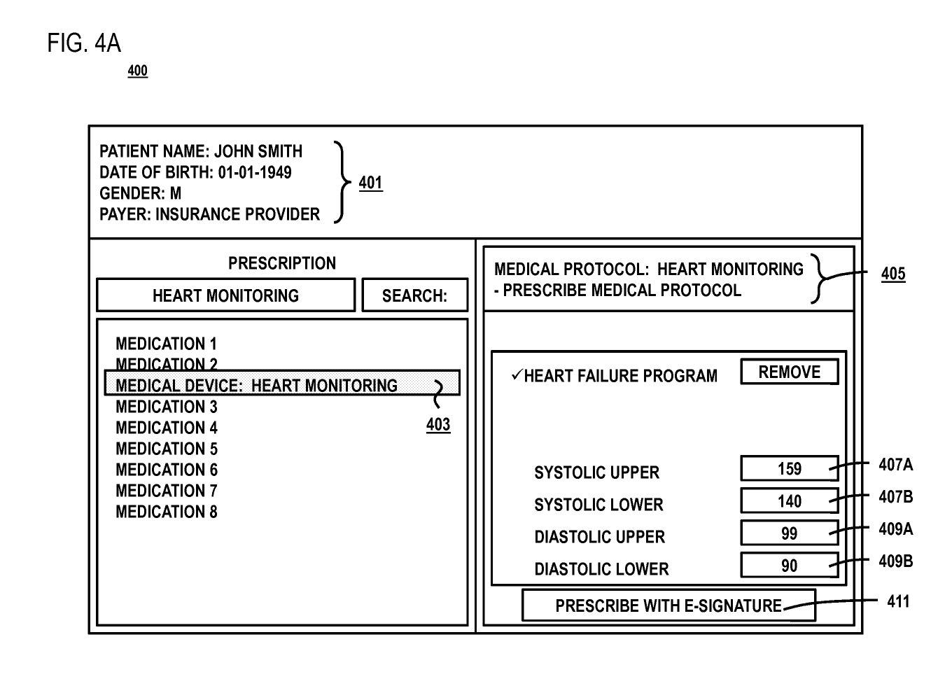

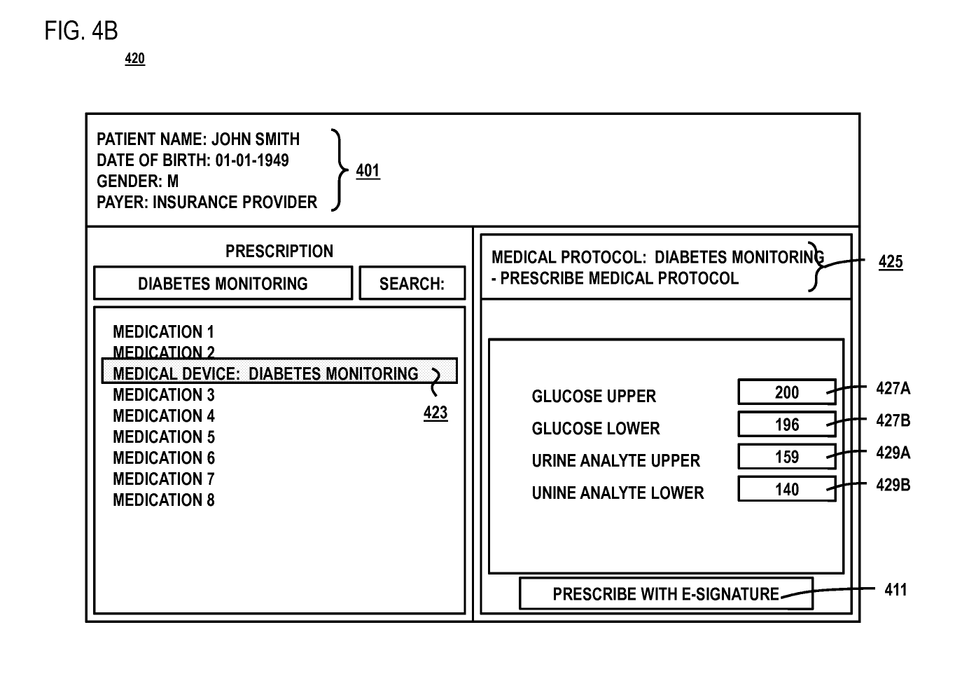

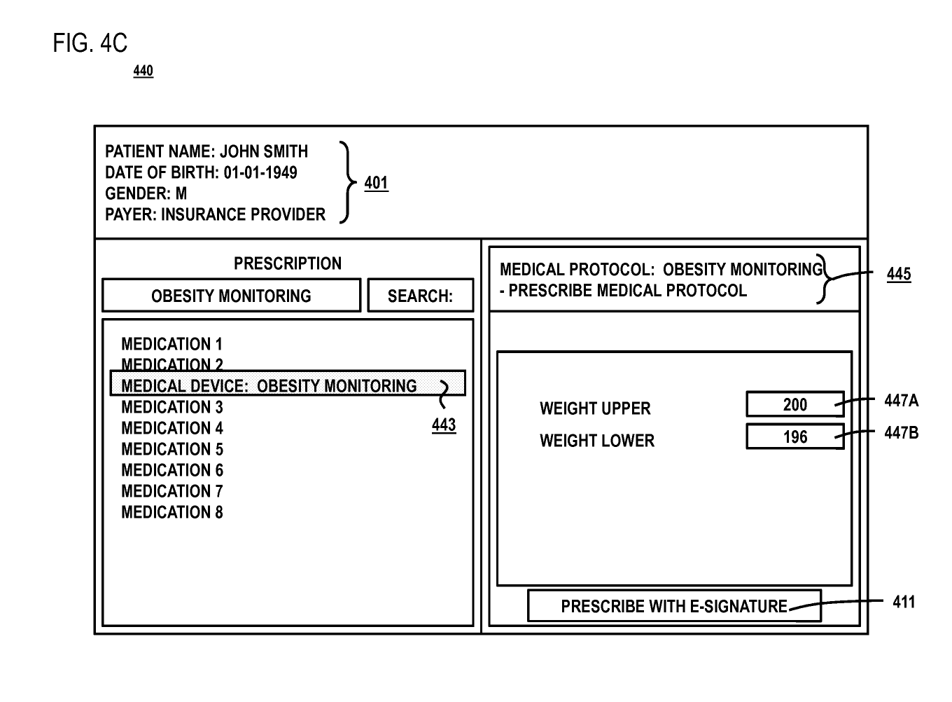

FIGS. 4A-4C are graphical representations of electronic prescriptions entered via a prescribing user interface utilized in the processes of FIGS. 3A-3C according to various embodiments. The graphical representations depict a command line interface of respective devices involved in the receiving and/or processing of an electronic prescription. For the purpose of illustration, the receiving and/or processing of an electronic prescription transfer is facilitated by way of the EMR platform 115 and a client device that is to receive the electronic prescription (or a version thereof).

FIG. 4A is a graphical representation of an electronic prescription 400 for a heart monitoring medical protocol. The electronic prescription 400 includes a first section 401 for indicating patient information, a second section 403 for selecting a heart monitoring device, a third section 405 for selecting the biometric parameter(s) and the prescribed range(s), or a combination thereof. The electronic prescription 400 specifies biometric parameters for systolic pressure and diastolic pressure and prescribed ranges for each including systolic upper limit 407A, systolic lower limit 407B, diastolic upper limit 409A and diastolic lower limit 409B. Once the parameters and prescribed ranges are entered, the electronic prescription is executed via electronic signature 411.

FIG. 4B is a graphical representation of an electronic prescription 420 for a diabetes monitoring medical protocol. The electronic prescription 420 includes the first section 401 for indicating patient information, a second section 423 for selecting a diabetes monitoring device, a third section 425 for selecting the biometric parameter(s) and the prescribed range(s), or a combination thereof. The electronic prescription 420 specifies biometric parameters for blood glucose and a urine analyte and prescribed ranges for each including glucose upper limit 427A, glucose lower limit 427B, urine analyte upper limit 429A and urine analyte lower limit 429B. Once the parameters and prescribed ranges are entered, the electronic prescription is executed via electronic signature 411.

FIG. 4C is a graphical representation of an electronic prescription 440 for an obesity monitoring medical protocol. The electronic prescription 440 includes the first section 401 for indicating patient information, a second section 443 for selecting an obesity monitoring device, a third section 445 for selecting the biometric parameter(s) and the prescribed range(s), or a combination thereof. The electronic prescription 440 specifies biometric parameters for body weight and a prescribed range including weight upper limit 447A and weight lower limit 447B. Once the parameter and prescribed range are entered, the electronic prescription is executed via electronic signature 411.

To the extent the aforementioned embodiments collect, store or employ personal information provided by individuals, it should be understood that such information shall be used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

The processes described herein for providing prescription-based biometric monitoring may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

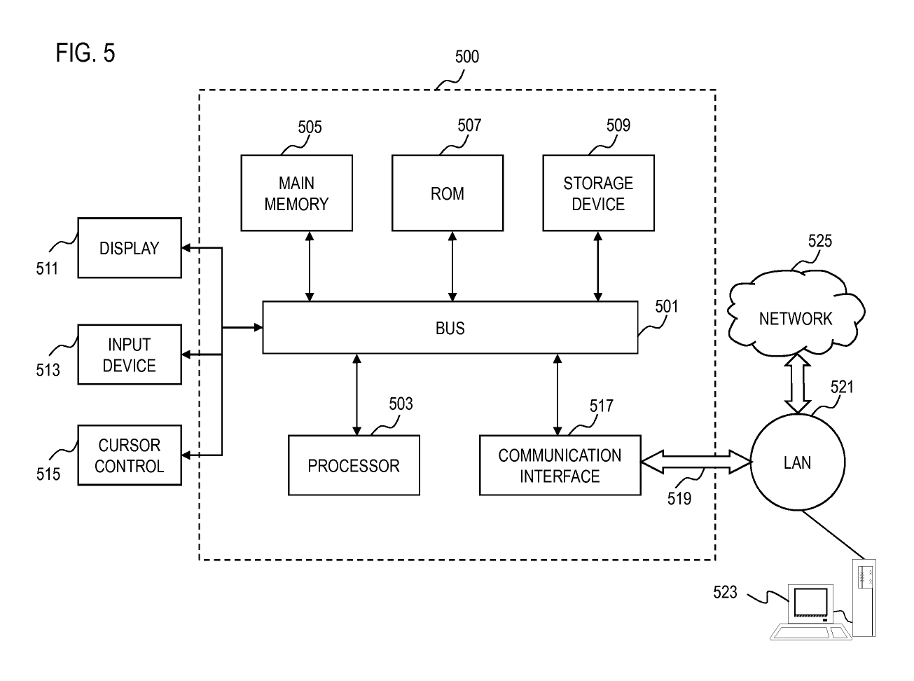

FIG. 5 is a diagram of a computer system 500 that can be used to implement various exemplary embodiments. The computer system 500 includes a bus 501 or other communication mechanism for communicating information and a processor 503 coupled to the bus 501 for processing information. The computer system 500 also includes main memory 505, such as a random access memory (RAM) or other dynamic storage device, coupled to the bus 501 for storing information and instructions to be executed by the processor 503. Main memory 505 can also be used for storing temporary variables or other intermediate information during execution of instructions by the processor 503. The computer system 500 may further include a read only memory (ROM) 507 or other static storage device coupled to the bus 501 for storing static information and instructions for the processor 503. A storage device 509, such as a magnetic disk or optical disk, is coupled to the bus 501 for persistently storing information and instructions.

The computer system 500 may be coupled via the bus 501 to a display 511, such as a cathode ray tube (CRT), liquid crystal display, active matrix display, or plasma display, for displaying information to a computer user. An input device 513, such as a keyboard including alphanumeric and other keys, is coupled to the bus 501 for communicating information and command selections to the processor 503. Another type of user input device is a cursor control 515, such as a mouse, a trackball, or cursor direction keys, for communicating direction information and command selections to the processor 503 and for controlling cursor movement on the display 511.

According to one embodiment of the invention, the processes described herein are performed by the computer system 500, in response to the processor 503 executing an arrangement of instructions contained in main memory 505. Such instructions can be read into main memory 505 from another computer-readable medium, such as the storage device 509. Execution of the arrangement of instructions contained in main memory 505 causes the processor 503 to perform the process steps described herein. One or more processors in a multi-processing arrangement may also be employed to execute the instructions contained in main memory 505. In alternative embodiments, hard-wired circuitry may be used in place of or in combination with software instructions to implement the embodiment of the present invention. Thus, embodiments of the present invention are not limited to any specific combination of hardware circuitry and software.

The computer system 500 also includes a communication interface 517 coupled to bus 501. The communication interface 517 provides a two-way data communication coupling to a network link 519 connected to a local network 521. For example, the communication interface 517 may be a digital subscriber line (DSL) card or modem, an integrated services digital network (ISDN) card, a cable modem, a telephone modem, or any other communication interface to provide a data communication connection to a corresponding type of communication line. As another example, communication interface 517 may be a local area network (LAN) card (e.g. for Ethernet™ or an Asynchronous Transfer Model (ATM) network) to provide a data communication connection to a compatible LAN. Wireless links can also be implemented. In any such implementation, communication interface 517 sends and receives electrical, electromagnetic, or optical signals that carry digital data streams representing various types of information. Further, the communication interface 517 can include peripheral interface devices, such as a Universal Serial Bus (USB) interface, a PCMCIA (Personal Computer Memory Card International Association) interface, etc. Although a single communication interface 517 is depicted in FIG. 5, multiple communication interfaces can also be employed.

The network link 519 typically provides data communication through one or more networks to other data devices. For example, the network link 519 may provide a connection through local network 521 to a host computer 523, which has connectivity to a network 525 (e.g. a wide area network (WAN) or the global packet data communications network now commonly referred to as the “Internet”) or to data equipment operated by a service provider. The local network 521 and the network 525 both use electrical, electromagnetic, or optical signals to convey information and instructions. The signals through the various networks and the signals on the network link 519 and through the communication interface 517, which communicate digital data with the computer system 500, are exemplary forms of carrier waves bearing the information and instructions.

The computer system 500 can send messages and receive data, including program code, through the network(s), the network link 519, and the communication interface 517. In the Internet example, a server (not shown) might transmit requested code belonging to an application program for implementing an embodiment of the present invention through the network 525, the local network 521 and the communication interface 517. The processor 503 may execute the transmitted code while being received and/or store the code in the storage device 509, or other non-volatile storage for later execution. In this manner, the computer system 500 may obtain application code in the form of a carrier wave.

The term “computer-readable medium” as used herein refers to any medium that participates in providing instructions to the processor 503 for execution. Such a medium may take many forms, including but not limited to non-volatile media, volatile media, and transmission media. Non-volatile media include, for example, optical or magnetic disks, such as the storage device 509. Volatile media include dynamic memory, such as main memory 505. Transmission media include coaxial cables, copper wire and fiber optics, including the wires that comprise the bus 501. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the present invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

FIG. 6 illustrates a chip set or chip 600 upon which an embodiment of the invention may be implemented. Chip set 600 is programmed to deliver messages to a user based on their activity status as described herein and includes, for instance, the processor and memory components described with respect to FIG. 5 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 600 can be implemented in a single chip. It is further contemplated that in certain embodiments the chip set or chip 600 can be implemented as a single “system on a chip.” It is further contemplated that in certain embodiments a separate ASIC would not be used, for example, and that all relevant functions as disclosed herein would be performed by a processor or processors. Chip set or chip 600, or a portion thereof, constitutes a means for performing one or more steps of enabling the transmission of files independent of a file transfer application or the throughput capabilities of the sending or receiving devices.

In one embodiment, the chip set or chip 600 includes a communication mechanism such as a bus 601 for passing information among the components of the chip set 600. A processor 603 has connectivity to the bus 601 to execute instructions and process information stored in, for example, a memory 605. The processor 603 may include one or more processing cores with each core configured to perform independently. A multi-core processor enables multiprocessing within a single physical package. Examples of a multi-core processor include two, four, eight, or greater numbers of processing cores. Alternatively or in addition, the processor 603 may include one or more microprocessors configured in tandem via the bus 601 to enable independent execution of instructions, pipelining, and multithreading. The processor 603 may also be accompanied with one or more specialized components to perform certain processing functions and tasks such as one or more digital signal processors (DSP) 607, or one or more application-specific integrated circuits (ASIC) 609. A DSP 607 typically is configured to process real-world signals (e.g., sound) in real time independently of the processor 603. Similarly, an ASIC 609 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 600 includes merely one or more processors and some software and/or firmware supporting and/or relating to and/or for the one or more processors.

The processor 603 and accompanying components have connectivity to the memory 605 via the bus 601. The memory 605 includes both dynamic memory (e.g., RAM, magnetic disk, writable optical disk, etc.) and static memory (e.g., ROM, CD-ROM, etc.) for storing executable instructions that when executed perform the inventive steps described herein to deliver messages to a user based on their activity status. The memory 605 also stores the data associated with or generated by the execution of the inventive steps.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method comprising:
receiving an electronic prescription associated with a patient, wherein the electronic prescription specifies a biometric parameter and a prescribed range for the biometric parameter;
receiving a biometric value for the biometric parameter collected by a monitoring device based on the electronic prescription, wherein the monitoring device is associated with the patient; and
triggering an alert notification based on a comparison of the biometric value against the prescribed range.

2. A method of claim 1, further comprising:
configuring a rules engine with a monitoring rule associated with the biometric parameter, the prescribed range, the monitoring device, or a combination thereof based on the electronic prescription,
wherein the comparison is performed using the rules engine.

3. A method of claim 2, wherein the monitoring rule includes a notification rule, a data recording rule, a data discarding rule, or a combination thereof based on the prescribed range.

4. A method of claim 1, further comprising:
presenting a prescribing user interface for inputting the electronic prescription,
wherein the prescribing user interface includes a first section for indicating patient information, a second section for selecting the monitoring device, a third section for selecting the biometric parameter and the prescribed range, or a combination thereof.

5. A method of claim 1, further comprising:
initiating a registration of the patient, a delivery order for the monitoring device, a creation of a medical record associated with the patient, an updating of the medical record, or a combination thereof based on the electronic prescription.

6. A method of claim 1, further comprising:
storing the biometric value, contextual information associated with the biometric value, the alert notification, or a combination thereof in a medical record associated with the patient.

7. A method of claim 1, further comprising:
transmitting the alert notification to a medical professional associated with the electronic prescription, the patient, or a combination thereof.

8. A method of claim 1, further comprising:
performing an authentication of the electronic prescription, a medical professional associated with the electronic prescription, or a combination thereof,
wherein the receiving of the biometric value, the collection of the biometric value by the monitoring device, the triggering of the alert, or a combination thereof is based on the authentication.

9. An apparatus comprising a processor configured to:
receive an electronic prescription associated with a patient, wherein the electronic prescription specifies a biometric parameter and a prescribed range for the biometric parameter;
receive a biometric value for the biometric parameter collected by a monitoring device based on the electronic prescription, wherein the monitoring device is associated with the patient; and
trigger an alert notification based on a comparison of the biometric value against the prescribed range.

10. An apparatus of claim 9, wherein the processor is further configured to:
configure a rules engine with a monitoring rule associated with the biometric parameter, the prescribed range, the monitoring device, or a combination thereof based on the electronic prescription,
wherein the comparison is performed using the rules engine.

11. An apparatus of claim 10, wherein the monitoring rule includes a notification rule, a data recording rule, a data discarding rule, or a combination thereof based on the prescribed range.

12. An apparatus of claim 9, wherein the processor is further configured to:
present a prescribing user interface for inputting the electronic prescription,
wherein the prescribing user interface includes a first section for indicating patient information, a second section for selecting the monitoring device, a third section for selecting the biometric parameter and the prescribed range, or a combination thereof.

13. An apparatus of claim 9, wherein the processor is further configured to:
initiate a registration of the patient, a delivery order for the monitoring device, a creation of a medical record associated with the patient, an updating of the medical record, or a combination thereof based on the electronic prescription.

14. An apparatus of claim 9, wherein the processor is further configured to:
store the biometric value, contextual information associated with the biometric value, the alert notification, or a combination thereof in a medical record associated with the patient.

15. An apparatus of claim 9, wherein the processor is further configured to:
transmit the alert notification to a medical professional associated with the electronic prescription, the patient, or a combination thereof.

16. An apparatus of claim 9, wherein the processor is further configured to:
perform an authentication of the electronic prescription, a medical professional associated with the electronic prescription, or a combination thereof,
wherein the receiving of the biometric value, the collection of the biometric value by the monitoring device, the triggering of the alert, or a combination thereof is based on the authentication.

17. A system comprising:
a monitoring device associated with a patient; and
a platform
wherein at least one of the monitoring device and the platform is configured
to receive an electronic prescription associated with the patient, wherein the electronic prescription specifies a biometric parameter and a prescribed range for the biometric parameter;
to receive a biometric value for the biometric parameter collected by the monitoring device based on the electronic prescription, wherein the monitoring device is associated with the patient; and
to trigger an alert notification based on a comparison of the biometric value against the prescribed range.

18. A system of claim 17, wherein at least one of the monitoring device and the platform is further configured to
configure a rules engine with a monitoring rule associated with the biometric parameter, the prescribed range, the monitoring device, or a combination thereof based on the electronic prescription,
wherein the comparison is performed using the rules engine.

19. A system of claim 18, wherein the monitoring rule includes a notification rule, a data recording rule, a data discarding rule, or a combination thereof based on the prescribed range.

20. A system of claim 17, wherein at least one of the monitoring device and the platform is further configured to:
present a prescribing user interface for inputting the electronic prescription,
wherein the prescribing user interface includes a first section for indicating patient information, a second section for selecting the monitoring device, a third section for selecting the biometric parameter and the prescribed range, or a combination thereof.
